(19) United States
(12) Patent Application Publication
(10) Pub. No.: US 2016/0019583 A1
(43) Pub. Date: Jan. 21, 2016

(54) SYSTEMS AND METHODS FOR SMOOTH AND EFFECTIVE BUDGET DELIVERY IN ONLINE ADVERTISING

(71) Applicant: Yahoo! Inc., Sunnyvale, CA (US)

(72) Inventor: Jian XU, Sunnyvale, CA (US)

(73) Assignee: YAHOO! INC., Sunnyvale, CA (US)

(21) Appl. No.: 14/336,836

(22) Filed: Jul. 21, 2014

(51) Int. Cl. G06Q 30/02

(52) U.S. Cl. CPC G06Q 30/0249

(57) ABSTRACT

Systems and methods are provided for smooth and effective budget delivery in online advertising. The system includes a storage including a plurality of user groups, where each user group corresponds to a layer comprising a layer-specific parameter. The system further includes a pacing control server in communication with the storage. The pacing control server is programmed to dynamically update the layer-specific parameter for each layer. The system also includes an ad server in communication with the pacing control server. The ad server is programmed to receive an ad call, assign a layer to the ad call, and get a pacing parameter corresponding to the assigned layer from the pacing control server.

### BACKGROUND

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising. Some models may include non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression (CPI) or number of impressions, cost per click (CPC) or number of clicks, cost per action (CPA) for some specified action(s), cost per conversion or purchase, or cost based at least in part on some combination of metrics, which may include online or offline metrics, for example.

A demand-side platform (DSP) is a computer system that allows buyers of digital advertising inventory to manage multiple ad exchange and data exchange accounts through one user interface. Real-time bidding for displaying online ads takes place within the ad exchanges, and by utilizing a DSP, marketers can manage their bids for the banners and the pricing for the data that they are layering on to target their audiences. Much like Paid Search, using DSPs allows users to optimize based on preset key performance indicators such as effective cost per click (eCPC), and effective cost per action (eCPA).

Generally, a DSP creates a unique opportunity for advertisers to control and maximize the impact of their ads throughout the lifetime of an ad campaign. Nowadays, more and more advertisers expect their ads to be shown smoothly throughout the purchased period in order to reach a wider range of audience, have a sustainable impact and create synergy with other medias such as TV commercials or billboards. Conversions may be defined differently by individual marketers, advertisers, and content creators. To online retailers, for example, a conversion may be defined as the sale of a product to a consumer whose interest in the item was initially sparked by clicking a banner advertisement. To content creators, a conversion may refer to a membership registration, newsletter subscription, software download, or other activity. However, since conversion feedbacks are very rare and often delayed, it is very challenging to achieve both budget and performance goals at the same time. Thus, there is a need to develop a DSP that can achieve the above two goals.

### SUMMARY

Different from existing solutions, the disclosed system considers the expected performance of an ad call and gives high performance ad calls more chance to be shown during the ad campaign. In other words, the disclosed system adopts a performance-based pacing strategy for smooth budget delivery in which the pacing rate for each ad call is determined dynamically.

In a first aspect, the embodiments disclose a computer system for smooth budget delivery that includes one or more devices having a processor and a non-transitory storage medium accessible to the hardware processor. The system includes a storage comprising a plurality of user groups, each user group corresponding to a layer comprising a layer-specific parameter. The system includes a pacing control server and an ad server in communication with the pacing control server. The pacing control server is programmed to dynamically update the layer-specific parameter for each layer. The ad server is programmed to receive an ad call, assign a layer to the ad call, and get a pacing parameter corresponding to the assigned layer from the pacing control server.

In a second aspect, the embodiments disclose a computer implemented method or program for smooth budget delivery. In the computer implemented method, the system stores a plurality of user groups, each user group corresponding to a layer comprising a layer-specific parameter. The system dynamically updates the layer-specific parameter for each layer. The system receives an ad call from a terminal device. The system assigns a layer to the ad call. The system obtains a pacing parameter corresponding to the assigned layer.

In a third aspect, the embodiments disclose a non-transitory storage medium programmed to store a set of instructions. The set of instructions to direct a computer system to perform the following acts: storing, in a storage, a plurality of user groups, each user group corresponding to a layer comprising a layer-specific parameter; dynamically updating the layer-specific parameter for each layer; receiving an ad call from a terminal device; assigning a layer to the ad call; and obtaining a pacing parameter corresponding to the assigned layer.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system for managing digital advertising campaign;

FIG. 3 illustrates an example system for managing digital advertising campaign;

FIG. 4A is an example data storage for managing digital advertising campaign;

FIG. 4B is an example embodiment for managing digital advertising campaign;

FIG. 5A is an example block diagram illustrating embodiments of the disclosure;

FIG. 5B is an example block diagram illustrating embodiments of the disclosure;

FIG. 6A is an example diagram illustrating embodiments of the disclosure; and

FIG. 6B is an example diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

For web portals like Yahoo!, advertisements may be displayed on web pages resulting from a user defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

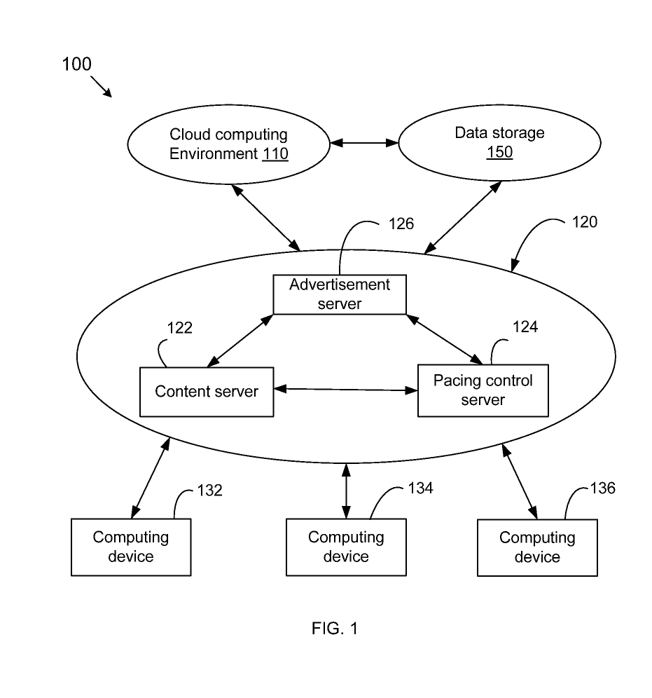

FIG. 1 is a block diagram of one embodiment of an environment 100 in which a system for managing digital advertising campaign may operate. However, it should be appreciated that the systems and methods described below are not limited to use with the particular exemplary environment 100 shown in FIG. 1 but may be extended to a wide variety of implementations.

The environment 100 may include a cloud computing environment 110 and a connected server system 120 including a content server 122, a pacing control server 124, and an advertisement server (may also be called as an ad server) 126. The server system 120 may act as a DSP system. The server system 120 may include additional servers for additional computing or service purposes. For example, the server system 120 may include search engine servers, servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The pacing control server 124 may be a computer system, one or more servers, or any other computing device known in the art, or the pacing control server 124 may be a computer program, instructions, and/or software code stored on a computer-readable storage medium that runs on a processor of a single server, a plurality of servers, or any other type of computing device known in the art. The pacing control server 124 is programmed to control digital ad campaigns in the DSP system.

The advertisement server 126 may be a computer system, one or more servers, or any other computing device known in the art. Alternatively, the advertisement server 126 may be a computer program, instructions and/or software code stored on a computer-readable storage medium that runs on a processor of a single server, a plurality of servers, or any other type of computing device known in the art. The advertisement server 126 is programmed to provide digital ads to a web user based on display conditions requested by the advertiser.

The cloud computing environment 110 and the connected server system 120 have access to a database system 150. The database system 150 may include one or more databases. At least one of the databases in the database system may be a user database that stores information related to a plurality of users. The user database may include a plurality of user groups, each user group corresponding to a layer including a layer-specific parameter. For example, the user database may include three user groups, where each group includes different users based on available use data related to each user. The user data may include social network data, search history data, browsing history data, shopping activity data, demographic data, or any data users agreed to share with the server system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

Generally, an advertiser or any other user can use a computing device such as computing devices 132, 134, 136 to access information on the server system 120. The advertisers may expect their ads to be shown smoothly throughout the purchased period in order to reach a wider range of audience, have a sustainable impact and create synergy with other medias such as TV. However, it is very challenging to achieve both budget and performance goals at the same time because conversion feedbacks are very rare and often delayed.

In the general solutions for smooth budget delivery, there is only a global pacing rate for each ad campaign. The pacing rate may be adjusted based on the spending in the last time slot and the desired expected spending in the coming time slot. However, within the same time period, any ad call will have the same chance to show the ad of an ad campaign if the ad campaign wins the ads auction. The general solutions do not and cannot differentiate high performance ad calls and low performance ad calls in order to give the high performance calls more opportunities. Moreover, the pacing rate adjustment is only based on the spending in the last time slot (e.g. 15 minutes) and it is prone to the natural traffic fluctuation.

Different from the general solutions, embodiments of the disclosed system and method consider the expected performance of an ad call and give high performance ad calls more chance to be shown in the ad campaign. In other words, the DSP system provides a performance-based pacing strategy for smooth budget delivery in which the pacing rate for each ad call is determined dynamically. Thus, the DSP system achieves both smooth budget delivery and high performance with the help of only a single variable: the pacing rate, which is determined based on the predicted performance and the budget spending status at every ad call.

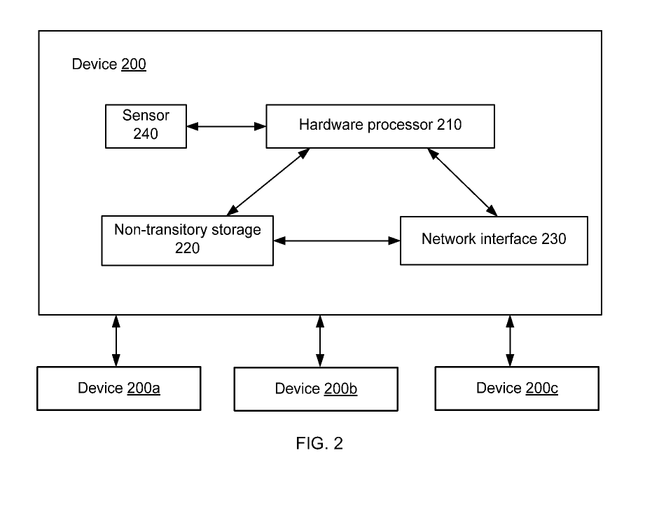

FIG. 2 illustrates an example device 200 for obtaining the pacing rate. The device may 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

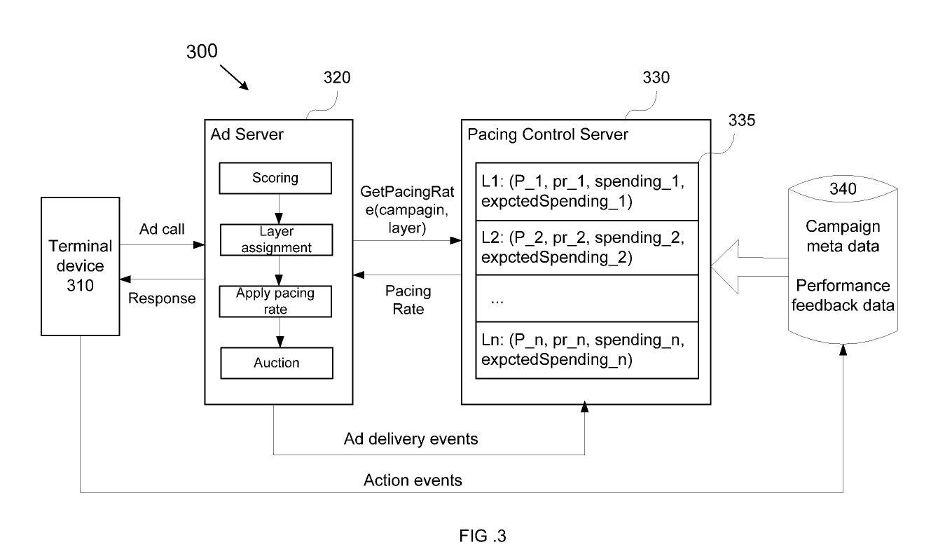

FIG. 3 illustrates an example system 300 for managing digital advertising campaign. The system 300 may include one or more devices illustrated in FIG. 2. For example, the system 300 includes an ad server 320 and a pacing control server 330, all of which may be implemented in one or more devices 200. The system also includes at least one terminal device 310 and a storage 340 accessible to the pacing control server 330. The storage 340 may include a non-transitory storage medium and a transitory storage medium. The storage 340 may include a plurality of data modules. The data modules may include campaign meta data and performance feedback data. The campaign meta data may include data defining total budget, budget spending preference, desired budget distribution, etc, for an ad campaign or individual advertisements. The budget spending preference may include options such as constant, linear increasing, non-linear increasing, linear decreasing, or a user defined function. The desired budget distribution may include an array of budget subtotals for each time period, e.g. different daily/hourly budgets. The performance feedback data may include action rate per layer, action metrics, preferred action duration, etc. The action may include viewing, clicking, registering, buying, or any action defined by the advertiser that is available on the advertiser's advertisement or website.

In the system 300, the advertiser may set the total budget of an ad campaign as B and the advertiser would like to spend the budget smoothly throughout N time slots, where each time slot is expected to spend a budget of b_i (i=1, . . . , N, and b_i>0). Advertisers may prefer b_i=B/N to reflect “smooth” delivery. Additionally or alternatively, the value of b_i may be set based on the other considerations such as the expected conversion number in each time slot. Without loss of generality, a solution is presented with the typical setting where remaining budget is expected to be evenly spent in remaining time slots.

In the DSP system 300, the terminal device 310 sends an ad call to the ad server 320. Upon receiving the ad call a, the ad server 320 may use a machine learning model that gives a performance score S(o,a) to quantify the expected performance if ad call a is served to the opportunity o. By design, a larger performance score indicates a potentially higher performance. For example, the expected performance score may be at least partially related to the expected conversion rate or return on investment (ROI). After obtaining the expected performance score, the ad server then assigns the ad call into a traffic layer based on the expected performance score. For example, the DSP system may have three layers and put the most promising ad calls in the top level layer, and bad performance ad calls into the bottom layer, where each layer has its own layer-specific pacing rate.

The ad server 320 may communicate with the terminal device 310 and the pacing control server 330 using a network. The ad server 320 may further include modules to implement different functions. For example, the ad server 320 is programmed to receive an ad call, assign a layer to the ad call, and get a pacing parameter corresponding to the assigned layer from the pacing control server 330. The pacing parameter may be the layer-specific pacing rate in the assigned layer. The ad server 320 may be programed to bid for the ad call using the pacing rate in an auction.

The pacing control server 330 is programmed to dynamically update the layer-specific parameter for each layer. The pacing control server 330 may adopt different strategies to update the layer-specific parameter, which includes at least one of: a layer-specific priority, a layer-specific spending, and a layer-specific pacing rate. The pacing control server 330 may use a first strategy to speed up the spending and a second strategy to slow down the spending. For example, the pacing control server 330 is programed to update the layer-specific pacing rates for all layers in a top-down fashion when an actual spending in a current time slot is less than a planned amount. The pacing control server 330 is programed to update the layer-specific pacing rates for all layers in a bottom-up fashion when an actual spending in a current time slot is more than a planned amount.

The pacing control server 330 further include a data storage medium 335, which may include a non-transitory storage medium and a transitory storage medium. The data storage 335 includes a plurality of user groups, each user group corresponding to a layer including a layer-specific parameter. The layered data storage 335 may store the priority, spending, and pacing rate for each layer. For example, the layered data storage 335 may include n layers, each layer is described as (priority, spending, pacing rate). The priority, denoted by P_1, P_2, or P_n, reflects the performance expectation: higher expected performance ad calls have higher priorities. The spending, denoted by spending_1, spending_2, or spending_n, is the in-layer spending in the latest time slot, where the time slot may be a preset time period such as an hour, six hours, a day, etc. The pacing rate, denoted by pr_1, pr_2, or pr_n, is the probability that the DSP system will apply to bid for an eligible ad call in this layer. Each layer may further include a layer index denoted by L1, L2, . . . Ln.

For each campaign, the layers may be set up differently. For example, a campaign to sell clothes may include less number of layers than a campaign to sell books. Further, the same layer in different campaigns may have different users. For example, the top layer in a campaign to sell video games may be completely different from the top layer in a campaign to sell skirts.

The data storage medium 335 may also be stored in a separate storage system such as the storage 340 accessible to the pacing control server 330. For example, if there are thousands of campaigns and each campaign includes tens of layers, a separate storage system may be adopted to store all the layered data for each campaign. The separate storage may also be used as a backup storage for emergency uses.

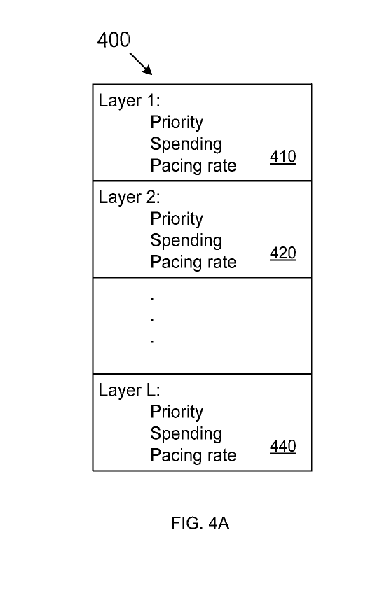

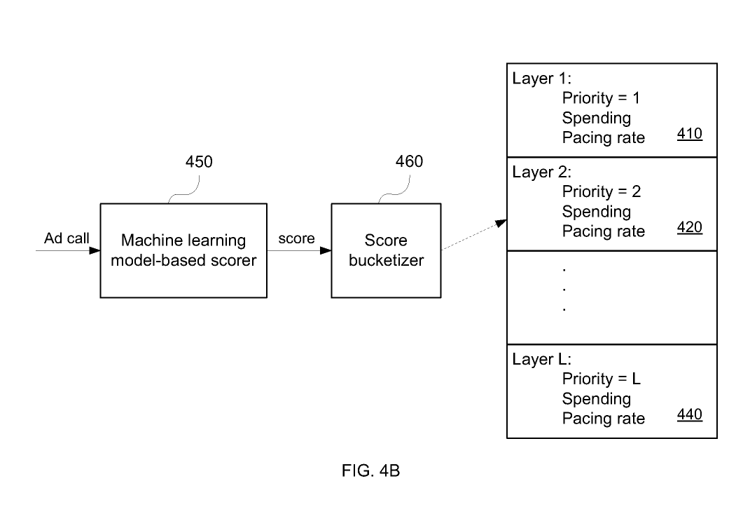

FIG. 4A is an example block diagram 400 illustrating the data storage 400 according to embodiments of the disclosure. The data storage 400 includes a plurality of layers 410, 420, . . . 440. Each layer includes at least one layer-specific parameter. The layer-specific parameter includes at least one of: a layer-specific priority, a layer-specific spending, and a layer-specific pacing rate. For example, the layer-specific priority may be an integer. The top layer 410 has a priority of 1, which is the highest priority. The second layer 420 has a priority of 2 and the bottom layer 440 has a priority of L. In the DSP system, the pacing rate of a higher priority layer should be no less than that of a lower layer. The top layer includes users with high expectation of business interest for the specific campaign. The lowest layer includes users with lowest expectation of business interest. For example, the top layer for a campaign to sell video games may include teenagers who have bought similar video games. The lowest layer for the same campaign to sell video games may include senior persons without child or grandchild at home.

Further, the pacing rate and the priority in each layer may be adjusted periodically depending on the actual spending and the expected spending. Accordingly, the run-time ad selection refers to the corresponding layer to retrieve the actual pacing rate to be applied when an ad call is received.

FIG. 4B is an example embodiment for managing digital advertising campaign. The DSP system may include a machine learning model-based scorer 450 that gives the performance score S(o,a) to quantify the expected performance when the ad a is served to opportunity o. Given an ad campaign, the DSP system may drop a and split the values of S(o) into different partitions and each partition will be assigned to a pacing rate layer. Higher scores are assigned to higher priority layers.

The DSP system may further include a score bucketizer 460 that puts the ad call into different buckets according to the score from the machine learning model-based scorer 450. The bucketizer 460 may group the raw scores between 0 and 1 to L groups so that each group includes the same number of raw scores in theory. For example, for a received ad call, the top layer may include users that have expected scores between (1−1/L) and 1. The bottom layer may include users that have expected scores between 0 and 1/L.

Each layer has an initial pacing rate. When there is enough historical data for an ad campaign, the DSP system may leverage the histogram of the scores and bid-win rates to derive the initial pacing rate for each layer prᵢ=bᵢ/(#adcallᵢ*winrateᵢ*CPM), where b_i is the budget to spend in i-th layer (i=1, . . . , L), #adcallᵢ is the number of ad calls in the i-th layer, winrateᵢ is the winning rate of the i-th layer in the past auctions, and CPM denotes cost per thousand impressions. Otherwise, the DSP system assigns default pacing rates to the different layers arbitrarily (e.g. set the pacing rate of top priority layer as 1.0, rest as 0.0).

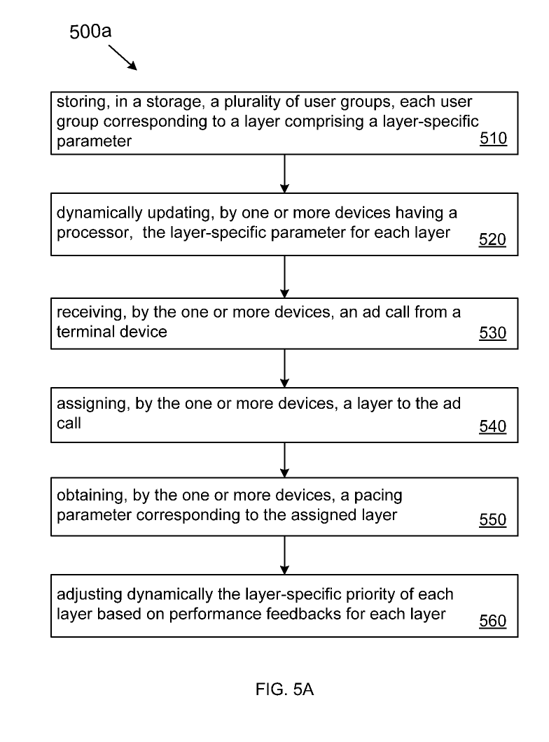

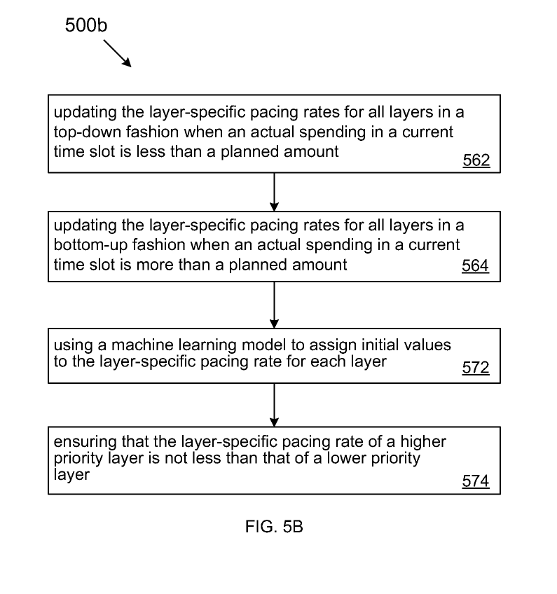

FIG. 5A is an example block diagram 500a illustrating embodiments of the disclosure. The block diagram 500a may be implemented by a computer system 300 in FIG. 3. The computer implemented method according to the example block diagram 500a includes the following acts. Other acts may be added or substituted.

In act 510, the computer system stores, in a storage, a plurality of user groups, each user group corresponding to a layer including a layer-specific parameter. The layer-specific parameter may include at least one of: a layer-specific priority, a layer-specific spending, and a layer-specific pacing rate. The storage may be included in a server computer such as the pacing control server 330 in FIG. 3. The storage may be partially included in a separate storage such as the database system 340 in FIG. 4. Either way, the storage divides users to different groups based on the respective expected performances of the users.

In act 520, the computer system dynamically updates the layer-specific parameter for each layer. Each layer may have its own pacing rate. The higher layers have a larger pacing rate than the lower layers so that the performance is optimized. At each timestamp, the computer system may adjust pacing rates in layer-by-layer adjustment to adjust the budget delivery. For a specific ad campaign, the computer system may use a first strategy to speed up the spending and a second strategy to slow down the spending. The first strategy may be adopted when an actual spending in a current time slot is less than the planned amount. The second strategy may be adopted when the actual spending in a current time slot is more than the planned amount. No adjustment is required when the actual spending in a current time slot is equal to the planned amount.

In act 530, the computer system receives an ad call from a terminal device. The ad call may include information about the terminal device, the user information of the terminal device, the webpage information where the ad will be presented with, and other information related to the ad to be presented.

In act 540, the computer system assigns a layer to the ad call. The computer system may assign the ad calls into different traffic layers based on their expected performances. The expected performances may be measured by a scorer 450 in FIG. 4B.

In act 550, the computer system obtains a pacing parameter corresponding to the assigned layer. The pacing parameter may be the layer-specific pacing rate in the assigned layer. Additionally or alternatively, the pacing parameter may be any parameter the includes the information about the layer-specific pacing rate in the assigned layer. The computer system may include an ad server 320 and a pacing control server 330 as shown in FIG. 3. The ad server 320 may send a request GetPacingRate( ) to the pacing control server 330. The request GetPacingRate( ) includes the required information to identify the campaign and corresponding layer. In return, the pacing control server 330 sends the layer-specific pacing rate back to the ad server 320.

In act 560, the computer system dynamically adjusts the layer-specific priority of each layer based on performance feedbacks for each layer. Generally, the priority adjustment happens when the machine learning model does not work perfectly. For example, within the layer assignment framework, the lower priority layers may have a higher performance in real campaigns. In that case, the computer system allows the priorities of different layers to be self-adjusted dynamically. The adjustment may be based on performance feedbacks such as click through rate (CTR) or other action rate. Layer priorities are re-ranked based on the statistics of the performance feedbacks.

FIG. 5B is an example block diagram 500b illustrating embodiments of the disclosure. The acts in block diagram 500b may be combined with the acts in the block diagram 500a shown in FIG. 5A. Similarly, the acts in block diagram 500b may be implemented by a computer system 300 disclosed in FIG. 3. The computer implemented method according to the example block diagram 500b includes the following acts. Other acts may be added or substituted.

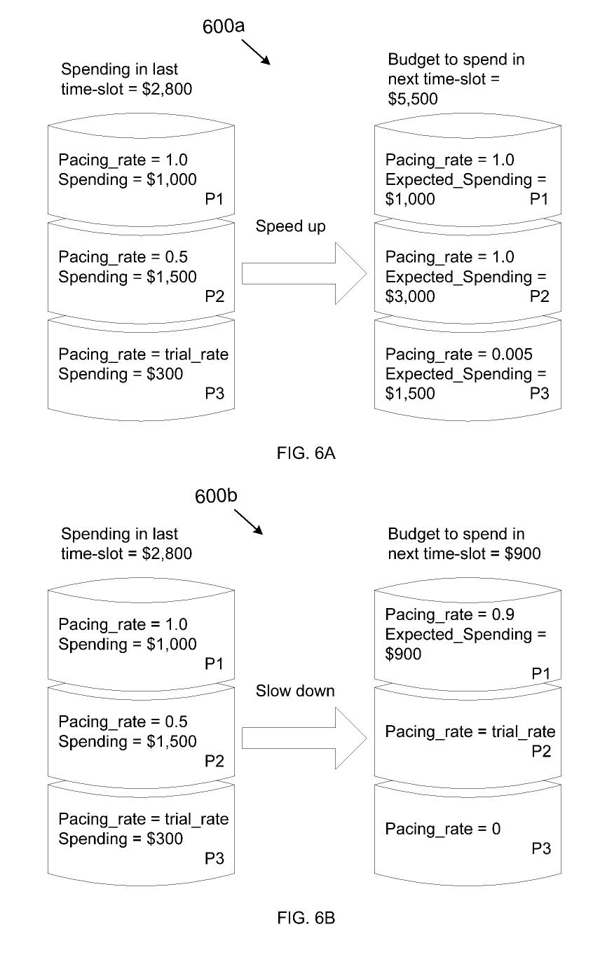

In act 562, to speed up spending budget on ads delivery, the computer system updates the layer-specific pacing rates for all layers in a top-down fashion when an actual spending in a current time slot is less than a planned amount. This act may be further described using FIG. 6A.

FIG. 6A is an example diagram illustrating embodiments of the disclosure to speed up spending. At the end of each time slot (also known as the beginning of the next time slot), the computer system may adjust the layer-specific pacing rates so that the planned amount of budget b_i can be spent in the next time slot. Suppose the actual spending in the current time slot is S, the residual is defined as R=b_i−S. If R equals to zero, no adjustment needed by the computer system. If R>0, which means delivery should speed-up, the computer system is programmed to adjust the pacing rates in a top-down fashion. Following is an example pseudo program code to implement the top-down adjustment of the pacing rate pr(l) in each layer l.

| | |
|---|---|
| 1 | IF( R > 0 ) // Speed up |
| 2 | FOREACH layer l in descending priority order |
| 3 | IF(R > 0) // still need to speed up |
| 4 | $pr ( l ) = MINIMUM ( 1.0 , last\_pr ( l ) * \frac{spending ( l ) + R}{spending ( l )} )$ |
| 5 | R = R − spending(l) * (1.0 − last_pr(l))/last_pr(l) |
| 6 | IF(R < 0 && l is not the lowest layer) |
| 7 | pr(l − 1) = default_trial_rate |
| 8 | l = l − 1 |
| 9 | ELSE // Residual has been offset |
| 10 | pr(l) = 0.0 |

Starting from the top priority layer P1, the computer system increases the pacing rate of each layer to offset R. Suppose l is the last layer in which the pacing rate is adjusted, the computer system may give the layer next to l but with lower priority a default trial delivery rate to prepare for future speed-ups. Here, as shown in FIG. 6A, R=5,500−2,800=2,700 is greater than zero. The pacing rate in layer P2 is increased from 0.5 to 1.0. The expected spending for layer P3 is the remaining of the budget $5,500−($1,000+$3,000)=$1,500. The constant trial rate may be set as any arbitrary number. For example, when the trial rate is set as 0.001 in layer P3, the pacing rate is increased to 0.005 accordingly because the expected spending ($1,500) is five times of the spending ($300) in the last time-slot.

In act 564, to slow down spending budget on ads delivery, the computer system updates the layer-specific pacing rates for all layers in a bottom-up fashion when an actual spending in a current time slot is more than a planned amount. This act may be further described using FIG. 6B.

FIG. 6B is an example diagram illustrating embodiments of the disclosure to slow down spending. At the end of each time slot, the computer system may adjust the layer-specific pacing rates so that the planned amount of budget b_i can be spent in the next time slot. If R=b_i−S<0, which means delivery should slow-down, the computer system is programmed to adjust the pacing rates in a bottom-up fashion. For each layer whose pacing rate is not zero, decrease the pacing rate of each layer to offset R. Suppose l is the last layer in which the pacing rate is adjusted, the computer system gives the layer next to l but with lower priority a default trial delivery rate to prepare for future speed-ups. Following is an example pseudo program code to implement the top-down adjustment of the pacing rate pr(l) in each layer l.

| | |
|---|---|
| 1 | IF( R < 0 ) // Slow down |
| 2 | FOREACH layer l in ascending priority order |
| 3 | IF(R < 0) // Still need to slow down |
| 4 | $pr ( l ) = MAXIMUM ( 0.0 , last\_pr ( l ) * \frac{spending ( l ) + R}{spending ( l )} )$ |
| 5 | R = R + spending(l) |
| 6 | IF (R > 0 && l is not the lowest layer) |
| 7 | pr(l − 1) = default_trial_rate |
| 8 | ELSE // Residual has been offset, copy the pacing rate |
| | for rest of the layers |
| 9 | pr(l) = last_pr(l) |

As shown in FIG. 6B, if the spending in the last time slot is $2,800 and the budget to spend in the next time slot is $900. R=900−2,800=−1700 is less than zero. The computer system first set the pacing rate in layer P3 to 0 because last_pr(l)*[spending(l)+R]/spending(l) is less than zero. For layer P2, because it is not the lowest layer, the pacing rate is set to a trial rate for future references in case that the spending needs to be increased. Similar to FIG. 6A, the constant trial rate may be set as any arbitrary small number such as 0.001.

When the constant trial rate is too small or the time slot is too short, there may be cases that the actual spending in the last time slot may be too small or is zero. In that case, to overcome the deficiency of pacing rate adjustment using only previous time-slot statistics, the computer system may smooth the previous time-slot spending with historical data. Thus, the computer system may use the weighted sum of true spending as an estimate of the previous spending. The computer system may tune the smoothing factors to decide if the computer system is confident with the spending observed in the last time-slot. The computer system may apply different smoothing factors to different layers respectively.

For example, the smoothed estimate may be calculated using the following equation:

SmoothedLastSpending=α*ObservedLastSpending+(1−α)*EstimatedLastSpending(0≦α≦1)

where α is the smoothing factor which may be different from layer to layer. With the smoothed last spending, the pacing rate for the coming time slot may be calculated as:

PacingRate=LastPacingRate*DesiredNextSpending/SmoothedLastSpending.

In act 572, the computer system is programmed to use a machine learning model to assign initial values to the layer-specific pacing rate for each layer. This act may follow the act 510 in FIG. 5A.

In act 574, the computer system is programed to ensure that the layer-specific pacing rate of a higher priority layer is not less than that of a lower priority layer. This act may follow the adjustment of the layer-specific priority in act 560 in FIG. 5A.

The disclosed computer implemented method may be stored in computer-readable storage medium. The computer-readable storage medium is accessible to at least one hardware processor. The processor is programmed to implement the stored instructions to assign ad calls into different traffic layers based on their expected performances.

From the foregoing, it can be seen that the present embodiments provide a computer system that includes a pacing control server and an ad server. The computer systems include layered data structure and intelligent adjustment algorithms to support performance-based pacing. The computer systems and methods provide a performance-based pacing solution that takes care of both smooth budget delivery and performance. The computer systems and methods achieve both smooth budget delivery and high performance with the help of a single variable: the pacing rate. The pacing rate is determined dynamically so that the pacing rate at a very ad call is determined based on the predicted performance as well as the budget spending status.

It is therefore intended that the foregoing detailed description be regarded as illustrative rather than limiting, and that it be understood that it is the following claims, including all equivalents, that are intended to define the spirit and scope of this invention.

What is claimed is:

1. A system for managing digital advertising campaign, comprising:
a storage comprising a plurality of user groups, each user group corresponding to a layer comprising a layer-specific parameter;
a pacing control server in communication with the storage, the pacing control server programmed to dynamically update the layer-specific parameter for each layer; and
an ad server in communication with the pacing control server, the ad server programmed to receive an ad call, assign a layer to the ad call, and get a pacing parameter corresponding to the assigned layer from the pacing control server.

2. The system of claim 1, wherein the layer-specific parameter comprises at least one of: a layer-specific priority, a layer-specific spending, and a layer-specific pacing rate.

3. The system of claim 2, wherein the pacing control server is programed to update the layer-specific pacing rates for all layers in a top-down fashion when an actual spending in a current time slot is less than a planned amount.

4. The system of claim 2, wherein the pacing control server is programed to update the layer-specific pacing rates for all layers in a bottom-up fashion when an actual spending in a current time slot is more than a planned amount.

5. The system of claim 2, wherein the pacing control server is programed to dynamically adjust the layer-specific priority of each layer based on performance feedbacks for each layer.

6. The system of claim 2, wherein the layer-specific priority characterizes performance of all users in a corresponding layer, the layer-specific spending characterizes total spending in the corresponding layer in a latest time slot, and the layer-specific pacing rate indicates a probability to bid for an eligible ad call in the corresponding layer.

7. The system of claim 6, wherein the pacing control server is programed to use a machine learning model to assign initial values to the layer-specific pacing rate for each layer.

8. The system of claim 7, wherein the pacing control server is programed to ensure that the layer-specific pacing rate of a higher priority layer is not less than that of a lower priority layer.

9. A method for managing digital advertising campaign, comprising:
storing, in a storage, a plurality of user groups, each user group corresponding to a layer comprising a layer-specific parameter;
dynamically updating, by one or more devices having a processor, the layer-specific parameter for each layer;
receiving, by the one or more devices, an ad call from a terminal device;
assigning, by the one or more devices, a layer to the ad call; and
obtaining, by the one or more devices, a pacing parameter corresponding to the assigned layer.

10. The method of claim 9, wherein the layer-specific parameter comprises at least one of: a layer-specific priority, a layer-specific spending, and a layer-specific pacing rate.

11. The method of claim 10, further comprising:
updating the layer-specific pacing rates for all layers in a top-down fashion when an actual spending in a current time slot is less than a planned amount.

12. The method of claim 10, further comprising:
updating the layer-specific pacing rates for all layers in a bottom-up fashion when an actual spending in a current time slot is more than a planned amount.

13. The method of claim 10, further comprising:
adjusting dynamically the layer-specific priority of each layer based on performance feedbacks for each layer.

14. The method of claim 10, wherein the layer-specific priority characterizes performance of all users in a corresponding layer, the layer-specific spending characterizes total spending in the corresponding layer in a latest time slot, and the layer-specific pacing rate indicates a probability to bid for an eligible ad call in the corresponding layer.

15. The method of claim 14, further comprising:
using a machine learning model to assign initial values to the layer-specific pacing rate for each layer.

16. The method of claim 15, further comprising:
ensuring that the layer-specific pacing rate of a higher priority layer is not less than that of a lower priority layer.

17. A non-transitory storage medium programmed to store a set of instructions, the set of instructions to direct a computer system to perform acts of:
storing, in a storage, a plurality of user groups, each user group corresponding to a layer comprising a layer-specific parameter;
dynamically updating, by one or more devices having a processor, the layer-specific parameter for each layer;
receiving, by the one or more devices, an ad call from a terminal device;
assigning, by the one or more devices, a layer to the ad call; and
obtaining, by the one or more devices, a pacing parameter corresponding to the assigned layer.

18. The non-transitory storage medium of claim 17, wherein the layer-specific parameter comprises at least one of: a layer-specific priority, a layer-specific spending, and a layer-specific pacing rate.

19. The non-transitory storage medium of claim 18, wherein the set of instructions to direct the computer system to perform acts of:
updating the layer-specific pacing rates for all layers in a top-down fashion to speed up spending budget on ads delivery;
updating the layer-specific pacing rates for all layers in a bottom-up fashion to slow down spending budget on ads delivery; and
ensuring that the layer-specific pacing rate of a higher priority layer is not less than that of a lower priority layer.

20. The non-transitory storage medium of claim 18, wherein the layer-specific priority characterizes performance of all users in a corresponding layer, the layer-specific spending characterizes total spending in the corresponding layer in a latest time slot, and the layer-specific pacing rate indicates a probability to bid for an eligible ad call in the corresponding layer.
